(19) United States
(12) Patent Application Publication
(10) Pub. No.: US 2003/0083444 A1
(43) Pub. Date: May 1, 2003

(54) Slotted slurry take off

(76) Inventors: Robert R. McElvain, Bartlesville, OK (US); John D. Stewart, Friendswood, TX (US); Raymond G. Sewell, Houston, TX (US); Robert W. Bohmer, Bartlesville, OK (US); Casey T. Collins, Friendswood, TX (US); Ted Cymbaluk, Kemah, TX (US)

Correspondence Address: Herbert D. Hart lll, McAndrews, Held & Malloy, Ltd., 34th Floor, 500 West Madison Street, Chicago, IL, 60661, US

(21) Appl. No.: 10/314,016

(22) Filed: Dec. 5, 2002

Related U.S. Application Data
(62) Division of application No. 09/353,941, filed on Jul. 15, 1999.

(51) Int. Cl. C08F 2/00

(52) U.S. Cl. 526/64; 422/131; 422/133; 528/501

(57) ABSTRACT

Apparatus for removing a concentrated slurry from a flowing stream of slurry in a conduit characterized by a channel in an outlet area of the conduit, the outlet being adapted to continuously remove slurry. In a specific embodiment, an olefin polymerization apparatus is disclosed wherein monomer, diluent and catalyst are circulated in a continuous pipe loop reactor and product slurry is recovered by a continuous product take off means. The pipe has a channel or groove leading to the continuous product take off means. In one embodiment, the slurry is heated in a flash line heater and passed to a high pressure flash where a majority of the diluent is separated and thereafter condensed by simple heat exchange, without compression, and thereafter recycled, bottoms from the high pressure flash being passed to a low pressure flash where polymer is recovered and entrained liquid is flashed overhead. In another embodiment the flash line feeds a single flash chamber.

### BACKGROUND OF THE INVENTION

This invention relates to withdrawing a slurry of a solid in a liquid from a flowing stream of the slurry.

Addition polymerizations are frequently carried out in a liquid which is a solvent for the resulting polymer. When high density (linear) ethylene polymers first became commercially available in the 1950's this was the method used. It was soon discovered that a more efficient way to produce such polymers was to carry out the polymerization under slurry conditions. More specifically, the polymerization technique of choice became continuous slurry polymerization in a pipe loop reactor with the product being taken off by means of settling legs which operated on a batch principle to recover product. This technique has enjoyed international success with billions of pounds of ethylene polymers being so produced annually. With this success has come the desirability of building a smaller number of large reactors as opposed to a larger number of small reactors for a given plant capacity.

Settling legs, however, do present two problems. First, they represent the imposition of a “batch” technique onto a basically continuous process. Each time a settling leg reaches the stage where it “dumps” or “fires” accumulated polymer slurry, it causes an interference with the flow of slurry in the loop reactor upstream and the recovery system downstream. Also the valve mechanism essential to periodically seal off the settling legs from the reactor upstream and the recovery system downstream requires frequent maintenance due to the difficulty in maintaining a tight seal with the large diameter valves needed for sealing the legs throughout, for instance, two hundred thousand cycles per year.

Secondly, as reactors have gotten larger (now 1 billion lbs/yr, for instance), logistic problems are presented by the settling legs. As the volume of the reactor goes up more withdrawal capacity is needed. However, because of the valve mechanisms involved, the size of the settling legs cannot easily be increased further. Hence the number of legs required begins to exceed the physical space available.

In spite of these limitations, settling legs have continued to be employed where olefin polymers are formed as a slurry in a liquid diluent. This is because, unlike bulk slurry polymerizations (i.e. where the monomer is the diluent) where solids concentrations of better than 60 percent are routinely obtained, generally much lower solids concentration is possible in ethylene homopolymerizations and ethylene/higher 1-olefin copolymerizations. Hence settling legs have been believed to be necessary to give a final slurry product at the exit to the settling legs of sufficiently high solids concentration to be commercially feasible. This is because, as the name implies, settling occurs in the legs to thus increase the solids concentration of the slurry finally recovered as product slurry. It is simply not commercially feasible to compress and/or cool large amounts of diluent for recycle to the reaction zone.

It is known to reduce expensive diluent compression by heating the slurry effluent to vaporize the diluent and passing the resulting solid/vapor slurry to a high pressure flash zone where most of the diluent is recovered overhead at high pressure to allow condensation. This overhead is then condensed by cooling and recycled. The bottoms from this high pressure flash which comprise the solid polymer and entrained liquid is then passed to a low pressure flash zone. This is quite effective but requires two separate flash operations which adds to the capital cost of the plant and also imposes the extra space considerations and operating costs of two separate flash systems.

Another factor affecting the maximum practical reactor solids is circulation velocity, with a higher velocity for a given reactor diameter allowing for higher solids. However the periodic upsets caused by settling leg “firing” limits the velocity which can be used.

### SUMMARY OF THE INVENTION

It is an object of this invention to continuously take off a slurry from a flowing stream at a solids concentration significantly higher than that of the flowing stream;

It is a further object of this invention to simplify diluent recovery and recycle; and

It is still yet a further object of this invention to provide a loop reactor apparatus having a continuous take off means.

In accordance with this invention, slurry is continuously withdrawn from a flowing stream by means of a slotted entry to continuous take off means.

In accordance with a more specific aspect of this invention, a portion of a circulating slurry in an olefin polymerization process is concentrated in a slotted exit zone, continuously withdrawn and passed to a flash separation zone.

### BRIEF DESCRIPTION OF THE DRAWINGS

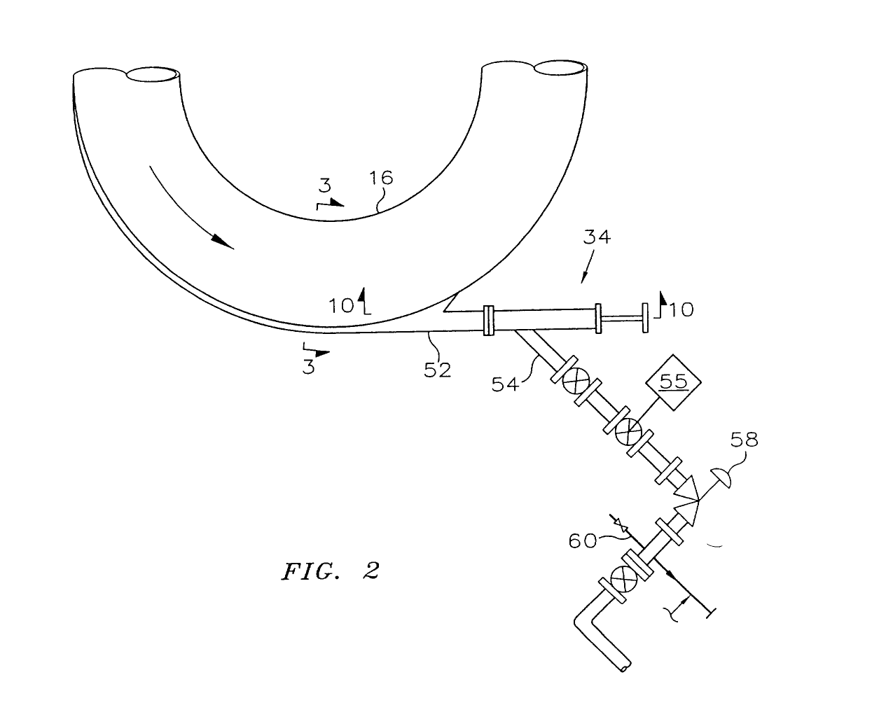

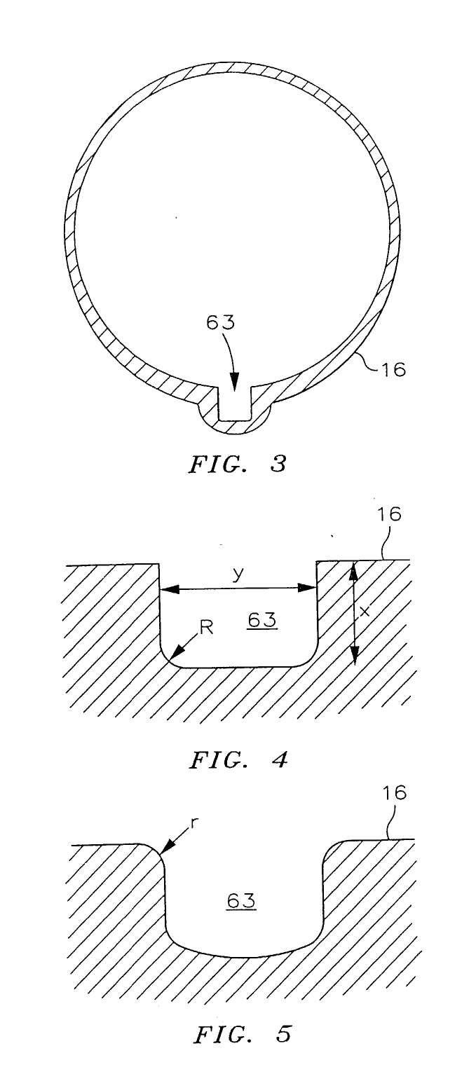

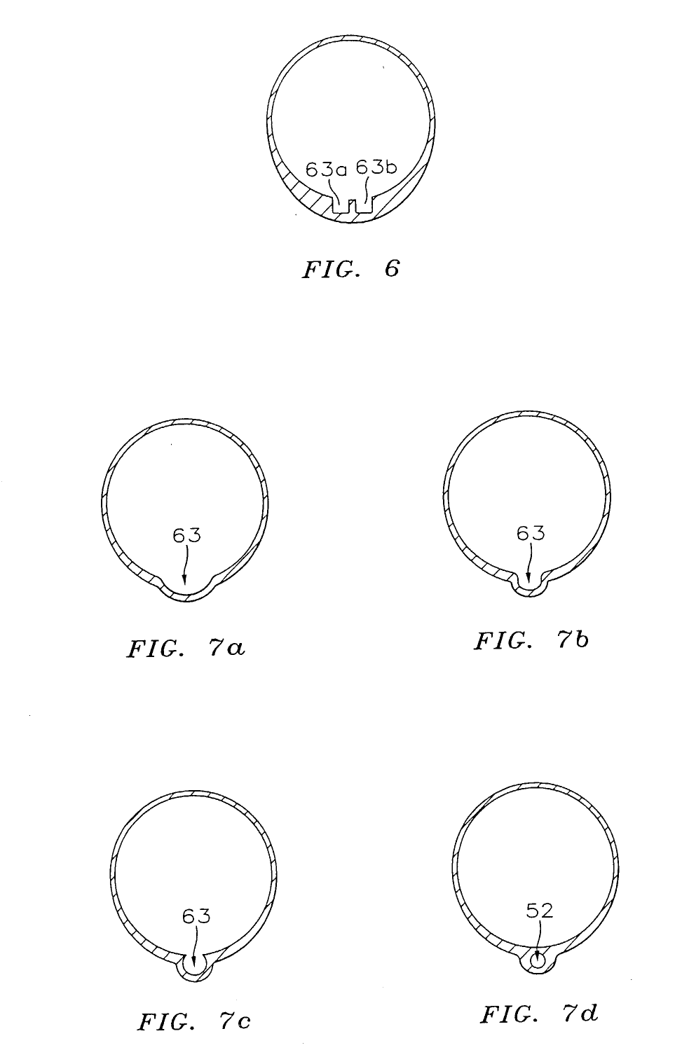

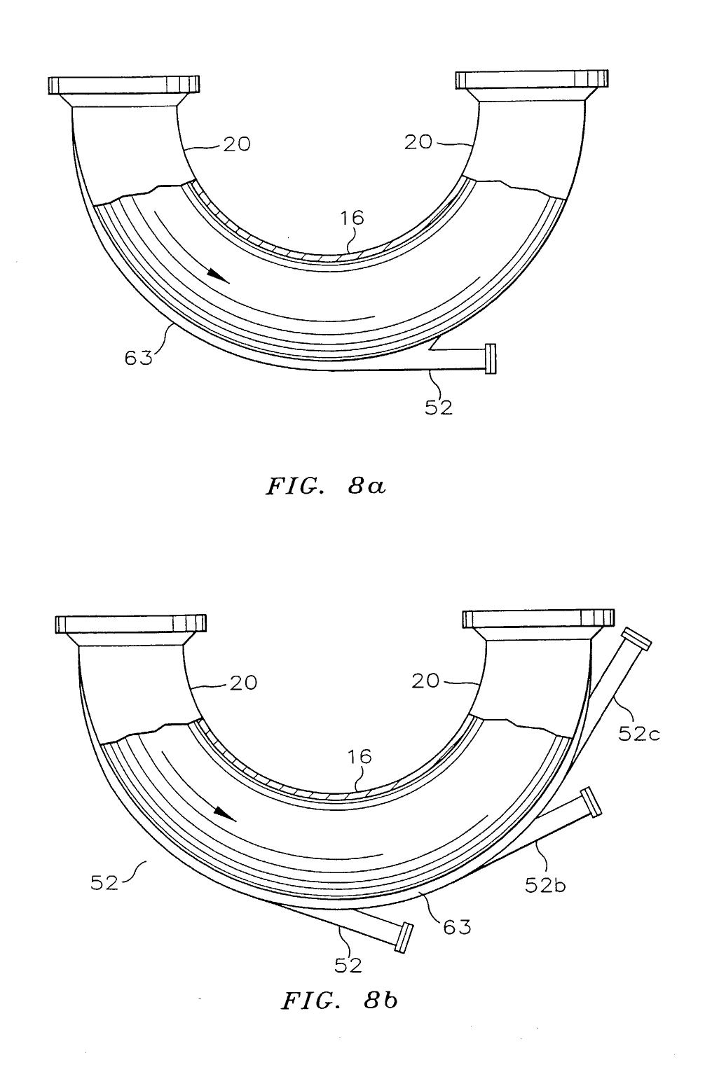

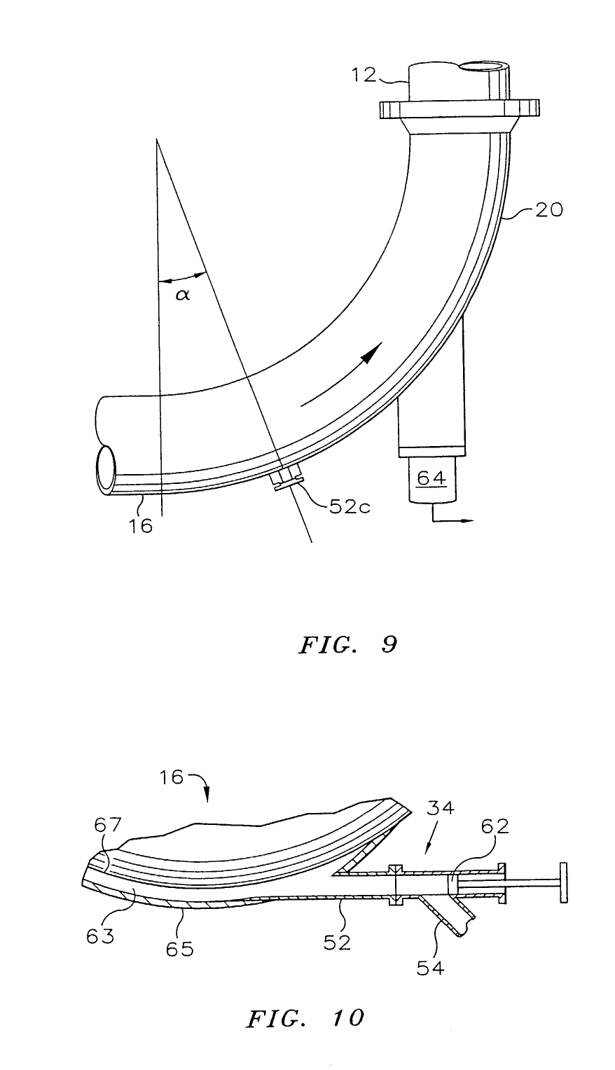

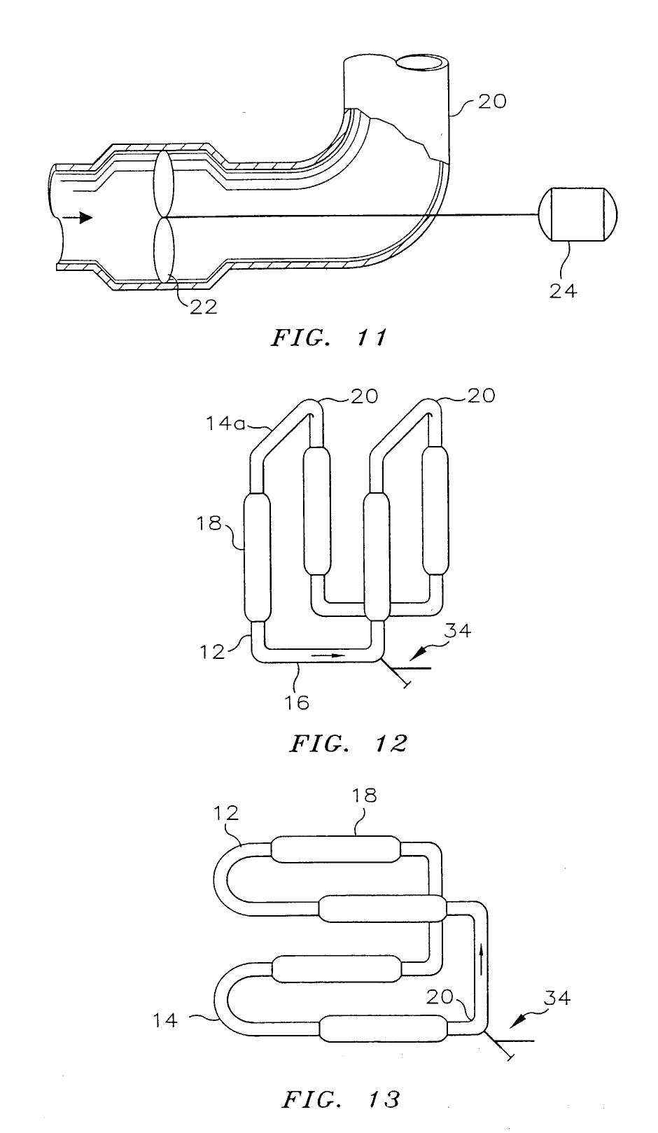

In the drawings, forming a part hereof, FIG. 1 is a schematic perspective view of a loop reactor having a continuous take off means and a downstream polymer recovery system; FIG. 2 is a side view a reactor loop of FIG. 1 showing the continuous take off mechanism in greater detail; FIG. 3 is a cross section along line 3-3 of FIG. 2 showing the slotted area (channel) in greater detail; FIG. 4 is a cross sectional view of one slot or channel configuration; FIG. 5 is a cross sectional view of one alternative channel configuration; FIG. 6 is a cross sectional view of another alternative channel configuration showing multiple parallel channels; FIG. 7a through 7d are progressive cross sectional views of a channel which changes in shape; FIG. 8a is a cross section of a tangential location for the take off cylinder of the continuous take off mechanism; FIG. 8b is a cross section similar to FIG. 8a showing multiple take off cylinders; FIG. 9 is a side view of an elbow of the loop reactor showing both a settling leg and a continuous take off cylinder; FIG. 10 is a cross section along line 10-10 of FIG. 2 showing a ram valve arrangement in the continuous take off mechanism; FIG. 11 is a cross sectional view of the impeller mechanism contained in the circulating pump; FIG. 12 is a schematic view showing another configuration for the loops wherein the upper segments 14a are straight horizontal segments and wherein the vertical segments are at least twice as long as the horizontal segments and FIG. 13 is a schematic view showing the longer axis disposed horizontally.

### DETAILED DESCRIPTION OF THE INVENTION

By simply taking a product slurry effluent stream off continuously, a small but significant increase in reactor solids concentration is made possible because the absence of upsets in the flowing slurry stream caused by the periodic “firing” of a batch settling leg. This absence of upsets also allows operating at higher circulation velocities which gives an additional small, but significant, increase reactor solids concentration.

However a dramatic increase in solids concentration is made possible by using a slotted entry (channel) to a continuous take off.

Commercial production of predominantly ethylene polymers in isobutane diluent using settling legs has historically been limited to a maximum solids concentration in the reactor of 37-40 weight percent for high 0.936-0.970 (more typically 0.945-0.960) density ethylene polymers with values as high as 42-46 weight per cent possible with maximized process enhancements. With lower (0.900-0.935 more typically 0.920-0.935) density polymers values as high as 36-39 are possible with process enhancements (but still using settling legs). Whatever the maximum for a given set of process conditions, improvement in solids concentration is possible simply by taking the slurry off continuously. However, in accordance with this invention, significant additional improvement can be obtained by using a slotted entry to a continuous take off.

It must be emphasized that in a commercial operation as little as a one percentage point increase in solids concentration is of major significance. However, with the slotted entry it is calculated that slurry densities which would otherwise be in the 42-46 weight per cent range can be increased to 55-58 per cent. If all of the benefits made possible simply by using the continuous take off per se are taken advantage of (such as higher circulation velocity) as much as 65 weight per cent is possible. Thus, increases of at least 10, or even 20 percentage points is possible. With lower density ethylene polymers where the starting point is 36-39 weight per cent solids in the reactor, similar increases (i.e. at least 10, or even 15 percentage points) can be achieved.

Referring now to the drawings, there is shown in FIG. 1 a loop reactor 10 having vertical pipe segments 12, upper pipe segments 14 and lower pipe segments 16. These upper and lower lateral pipe segments define upper and lower zones of horizontal or generally lateral (as opposed to straight vertical) flow. The reactor is cooled by means of two-pipe heat exchangers formed by pipe 12 and jacket 18. Each segment is connected to the next segment by a smooth bend or elbow 20 thus providing a continuous flow path substantially free from internal obstructions. As shown here, all of the upper segments and two of the lower segments are continuously curved and the remaining two lower segments are straight pipes connected at each end to a vertical segment by the smooth bend or elbow. The continuously curved segments can be simply two elbows connected together. Reference herein to lateral pipe segments is meant to include two 90 degree elbows affixed together, a smoothly curved segment or a straight pipe connected at each end by an elbow to a vertical pipe. Reference to attachment of a hollow withdrawal appendage to a curved “portion” of a lateral pipe segment is meant to include situations wherein the entire lateral segment is curved, as in the connection of two elbows together, as well as situations wherein a straight pipe is connected at each end by a curved elbow to a vertical segment. The polymerization mixture is circulated by means of impeller 22 (shown in FIG. 11) driven by motor 24. Monomer, comonomer, if any, and make up diluent are introduced via lines 26 and 28 respectively which can enter the reactor directly at one or a plurality of locations or can combine with condensed diluent recycle line 30 as shown. Catalyst is introduced via catalyst introduction means 32 which provides a zone (location) for catalyst introduction. The elongated hollow appendage for continuously taking off an intermediate product slurry is designated broadly by reference character 34.

FIG. 2 shows in greater detail the continuous take off appendage and shows it located in a continuously curved segment which is the preferred location. However, the continuous take off appendage can be located on any segment or any elbow.

FIG. 3 shows a cross section along line 3-3 of FIG. 2 showing channel (slot) 63.

FIG. 4 shows a cross section of a pipe segment 16 showing the relative depth (x) and width (y) of slot or channel 63. As shown here the slot has a curved shape where the vertical and bottom lateral walls join as depicted by radius “R”. While the vertical and bottom lateral wall can join at a right angle (R equals zero) this is less preferred.

FIG. 5 is a cross section similar to FIG. 4 wherein the bottom of the slot is one continuous curve. The juncture of the vertical wall and the inside surface of the pipe is depicted by radius “r”.

Thus, “R” generally has a value within the range of 0y to 0.5y, preferably from 0.01y to 0.25y. The junction of the vertical wall and the inside surface of the pipe can be a right angle as shown in FIG. 8 or can be a curve as shown in FIG. 9. Radius “r” can have a value within the same ranges set out for “R”. Unlike “R”, however, this junction is generally a right angle, i.e. “r” is 0.

The values for y can vary from 1 to 6 inches (2.5-15 cm) preferably 2 to 3 inches (5-7.6 cm). The values for x can vary from 0.1 to 4y, preferably from 0.5 to 1y, most preferably about 0.6 to 0.7y. In one embodiment R equals 0.5y, i.e. slot 63 is semicircular (assuming x is at least 0.5y). The curvature of the bottom wall of slot 63 does not have to be an actual radius, but can simply be any smoothly curved surface. Stated in terms relative to the pipe in which the slurry flows, y can be from 0.02-0.5, preferably 0.04 to 0.25, more preferably from 0.08 to 0.13 times the pipe diameter.

The wider the channel, the more flow or capacity the channel can provide. The deeper the channel the more squeeze or separation force that is exerted on the solids relative to the lighter liquids.

FIG. 6 depicts an alternative channel arrangement where a plurality, here two, of channels 63a and 63b are provided. Rather than have the multiple channels disposed at a radial angle around the pipe, they are preferably in a generally flattened section of the pipe with the center line of the flattened section at a radial angle of 0 to the center plane of the longitudinal segment as shown in this figure.

FIGS. 7a, 7b, 7c and 7d depict another alternative channel configuration where channel 63 starts out as a gentle swale (FIG. 7a), gradually progresses to a channel similar to that in FIG. 5 (FIG. 7b), then to a partially enclosed channel (FIG. 7c). Finally, as shown in FIG. 7d, channel 63 becomes tubular withdrawal line (take off cylinder) 52.

FIG. 8a shows the take off cylinder 52 affixed tangentially to the curvature of elbow 20 (which in conjunction with another elbow 20 forms a curved lower pipe segment) and affixed at a point just prior to the slurry flow turning upward. Slot 63 starts just as the pipe begins to bend and can gradually increase in depth as it approaches take off cylinder 52 or can increase in depth over a relatively short distance as shown here.

FIG. 8b is similar to FIG. 8a wherein the smooth curved lower pipe segment 16 is formed by two adjoined elbows 20. In this Figure there is shown multiple take off cylinders 52, 52b and 52c for multiple continuous take off mechanisms, slot 63 extending past the bottom of the bend and gradually tapering back in depth just upstream of the first continuous take off mechanism.

FIG. 9 shows three things. First, it shows take off cylinder 52c at a placement angle, alpha, to a plane that is (1) perpendicular to the centerline of lower pipe segment and (2) located at the downstream end of pipe segment 16 if it is straight or at the lowest point of the curve in the case of a continuously curved pipe segment 16. The angle with this plane is taken in the downstream direction from the plane. The apex for the angle is the center point of the elbow radius. The plane can be described as the horizontal or lateral segment cross sectional plane. Here the angle depicted is about 24 degrees. Second, it shows this take off cylinder, 52c oriented on a vertical centerline plane of lower pipe segment 16. Finally, it shows the combination of continuous take off mechanisms and a conventional settling leg 64 for batch removal, if desired. Preferably in such arrangements the continuous take off mechanism or mechanisms are located upstream of the settling leg so as to avoid the settling leg causing turbulence in the channel leading to the continuous take off mechanism or mechanisms.

As can be seen from the relative sizes, the continuous take off cylinders are much smaller than the conventional settling legs. Yet three 2-inch ID continuous take off appendages can remove more product slurry than six 8-inch ID settling legs. This is significant because with current large commercial loop reactors of 15,000-18000 gallon capacity, (or even 32,000 or more) six eight-inch settling legs are required. It is not desirable to increase the size of the settling legs because of the difficulty of making reliable valves for larger diameters. As noted previously, doubling the diameter of the pipe increases the volume four-fold and there simply is not enough room for four times as many settling legs to be easily positioned. Hence the invention makes feasible the operation of larger, more efficient reactors. Reactors of 30,000 gallons or greater are made possible by this invention. Generally the continuous take off cylinders will have a nominal internal diameter within the range of 1 inch to less than 8 inches. Preferably they will be about 2-3 inches internal diameter.

It is noted that there are three orientation concepts here. First is the attachment angle, i.e. tangential as in FIGS. 1, 2, 8a, 8b and 10 or perpendicular as in FIG. 9 or any angle between these two limits of 0 and 90 degrees.

Second is the placement angle relative to how far along a pipe segment curve that the take off is located as represented by placement angle alpha (FIG. 9). This can be anything from minus about 30 to plus 90 degrees but is preferably 0 to plus 90 degrees. If only one continuous take off mechanism is employed on a particular curved segment, the angle is preferably about 0 to plus 90 degrees as shown by take off cylinders 52, 52b or 52c of FIG. 8b. If multiple continuous take off mechanisms are employed on a particular 180 degree elbow one is preferably at a placement angle of about 0 as shown by take off cylinder 52 in FIG. 8b and the other or others at an angle of plus 20 to plus 90 degrees as represented by take off cylinders 52b and/or 52c of FIG. 8b. More than three take off mechanisms can be present although three or less is generally preferred. Nonetheless, as many as 6 or more could be present.

Third is the radial angle, beta, from the center plane of the longitudinal segment. This angle is preferably 0 or about 0. Even if it is desired to use multiple continuous take off mechanisms on a particular curved segment at the same orientation angle, alpha, the channel area would preferably be configured as shown in FIG. 6. That is, the channels would run parallel along a flattened outermost (generally bottom) area of the curved segment. Thus the radial angle of the center of the parallel channel area (or channel in the case of a single channel) would preferably be 0.

Referring now to FIG. 10, which is taken along section line 10-10 of FIG. 2, there is shown the smooth curve of lower pipe segment 16 having associated therewith the continuous take off mechanism 34 shown in greater detail. As shown, the mechanism comprises a take off cylinder 52 attached, in this instance, at a tangent to the outer surface of curved pipe segment 16. Coming off cylinder 52 is slurry withdrawal line 54. Disposed within the take off cylinder 52 is a ram valve 62 which serves two purposes. First it provides a simple and reliable clean-out mechanism for the take off cylinder if it should ever become fouled with polymer. Second, it can serve as a simple and reliable shut-off valve for the entire continuous take off assembly. This Figure shows lower pipe segment 16 expanded enough to see the cross section, 65, of the bulge in lower pipe section 16 forming channel 63. Also shown is shadow line 67 of the Junction of the wall of channel 63 and the general contour of the bottom surface of lower pipe section 16.

FIG. 11 shows in detail the reactor circulating pump means for continuously moving the slurry along its flow path. As can be seen in this embodiment the impeller 22 is in a slightly enlarged section of pipe which serves as the propulsion zone for the circulating reactants. Preferably the system is operated so as to generate a pressure differential of at least 18 psig preferably at least 20 psig, more preferably at least 22 psig between the upstream and downstream ends of the propulsion zone in a nominal two foot diameter reactor with total flow path length of about 950 feet using isobutane to make predominantly ethylene polymers. As much as 50 psig or more is possible. This can be done by controlling the speed of rotation of the impeller, reducing the clearance between the impeller and the inside wall of the pump housing or by using a more aggressive impeller design as is known in the art. This higher pressure differential can also be produced by the use of at least one additional pump.

Also, —compared with a system using settling legs—more aggressive circulation and/or larger diameter reactors can be employed. Generally the system is operated so as to generate a pressure differential, expressed as a loss of pressure per unit length of reactor, of at least 0.07, generally 0.07 to 0.15 foot pressure drop per foot of reactor length for a nominal 24 inch diameter reactor. Preferably, this pressure drop per unit length is 0.09 to 0.11 for a 24 inch diameter reactor. For larger diameters, a higher slurry velocity and a higher pressure drop per unit length of reactor is needed. The units for the pressure are ft/ft which cancel out. This assumes the density of the slurry which generally is about 0.45-0.6 g/cc.

Referring now to FIG. 12 the upper segments are shown as straight horizontal segments 14a connected to the vertical segments by elbows 20. The vertical segments are at least twice the length, generally about seven to eight times the length of the horizontal segments. For instance, the vertical flow path can be 190-225 feet and the horizontal (or generally lateral) segments 25-30 feet in flow path length. Any number of loops can be employed in addition to the four depicted here and the eight depicted in FIG. 1, but generally four or six are used. Reference to nominal two foot diameter means an internal diameter of about 21.9 inches. Flow length is generally greater than 500 feet, generally greater than 900 feet, with about 940 to 1,350 feet being quite satisfactory.

FIG. 13 shows the alternative of the longer axis being disposed horizontally.

Throughout this specification the term “lateral” as opposed to “vertical” in referring to the pipe segments is meant to broadly encompass either upper or lower straight horizontal segments or upper or lower curved segments which connect the vertical segments.

Commercial pumps for utilities such as circulating the reactants in a closed loop reactor are routinely tested by their manufacturers and the necessary pressures to avoid cavitation are easily and routinely determined.

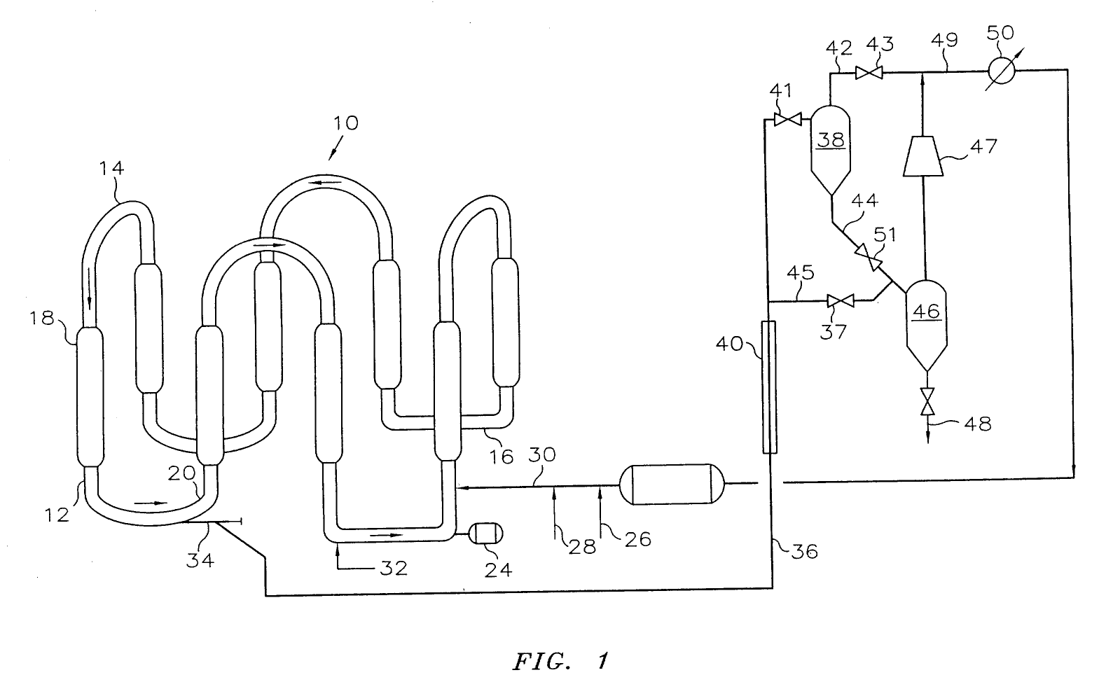

Channel 63 can be viewed as a small lateral concentration zone for concentrating solids of a slurry flowing in a larger flow zone such as a polymerization reactor pipe section 16 or a transfer pipe broadly. With simple lateral flow or the static condition in a settling leg there would be 1 g of force separating the heavier solids from the lighter liquid. However, while such separations are commonly done with static systems, a rapidly flowing stream has little time to allow concentration of the solids and must overcome turbulent suspension. But by placing the take off at or adjacent to a curve as the main zone descends and then curves to a generally lateral direction and then curves back upward, as much as 5 g or more can be obtained as a result of the centripetal force. Thus faster flow rates enhance, rather than restrict the separation. With 0.94-0.95 density ethylene polymers (polymer density being measured by ASTM D 1505-68) at a nominal 200 F. (93° C.) the isobutane liquid has a density of only about 0.45 g/cc. This difference, multiplied by the several g of force that can be generated results in excellent concentration of solids. This concentration zone generally extends from the point where the main flow zone begins to curve and extends to an outlet zone as shown in FIG. 8a and 8b for instance. This zone can taper, from a starting point, very gradually to the point of the outlet zone or if there are more than one outlet zone as shown in FIG. 8b then to the first outlet zone where it reaches its maximum depth. The width can taper too (becoming wider in the downstream direction), but generally the width remains constant or essentially constant. Alternatively the zone can taper rapidly to its final depth, for instance over a distance of 0.5 to 5 times its width. The length of this zone can be as much as pi times the radius of the concentration zone as in FIG. 8b to 0.5 pi times the radius as in FIG. 8a. Broadly the length can be from 0.01 to 1 pi times the radius.

This concentration zone is quite small relative to the entire reactor, generally having a total volume of from 0.02 to 5 gallons, preferably from 0.5 to 1 gallon. Stated relative to the reaction zone volume the concentration zone volume will be only about 0.00005 to 0.05, preferably from 0.0001 to 0.025 per cent of the reaction zone volume. Generally only about 0.5 to 10, preferably only 1 to 2 volume per cent of the reactor circulation is withdrawn via the continuous take off zone or zones during one circulation of the slurry through the reaction zone

Reactor slurry flow rate is generally within the range of 10,000 to 40,000, preferably 25,000 to 35,000 gallons/minute. The average time for the slurry to make one complete pass through the reaction zone is generally within the range of 20 to 90, preferably 30 to 60 seconds.

Referring now back to FIG. 1, the continuously withdrawn intermediate product slurry is passed via conduit 36 into a high pressure flash chamber 38. Conduit 36 includes a surrounding conduit 40 which is provided with a heated fluid which provides indirect heating to the slurry material in flash line conduit 36. The high pressure flash chamber zone can be operated at a pressure within the range of 100-1500 psia (7-105 kg/cm²), preferably 100-275 psia (7-19 kg/cm²), more preferably 125-200 psia (8.8-14 kg/cm²). The high pressure flash chamber zone can be operated at a temperature within the range of 100-250° F. (37.8-121° C.), preferably 130-230° F. (54.4-110° C.), more preferably 150-210° F. (65.6-98.9° C.). The narrower ranges are particularly suitable for polymerizations using 1-hexene comonomer and isobutane diluent, with the broader ranges being suitable for higher 1-olefin comonomers and hydrocarbon diluents in general.

The low pressure flash chamber zone can be operated at a pressure within the range of 1-50 psia (0.07-3.5 kg/cm²), preferably 5-40 psia (0.35-2.8 kg/cm²) more preferably 15-20 psia (1.1-1.4 kg/cm²). The low pressure flash tank zone can be operated at a temperature within the range of 100-250° F. (37.8-121° C.), preferably 130-230° F. (54.4-110° C.), more preferably 150-210° F. (65.6-98.9° C.). Generally the temperature in the low pressure flash chamber zone will be the same or 1-20° F. (0.6-11° C.) below that of the high pressure flash chamber zone although operating at a higher temperature is possible. The narrower ranges are particularly suitable for polymerizations using 1-hexene comonomer and isobutane diluent, with the broader ranges being suitable for higher 1-olefin comonomers and hydrocarbon diluents in general.

Vaporized diluent exits the flash chamber 38 via conduit 42 for further processing which includes condensation by simple heat exchange using recycle condenser 50, and return to the system, without the necessity for compression, via recycle diluent line 30. Recycle condenser 50 can utilize any suitable heat exchange fluid known in the art under any conditions known in the art. However preferably a fluid at a temperature that can be economically provided is used. A suitable temperature range for this fluid is 40 degrees F to 130 degrees F. Polymer particles and entrained liquid are withdrawn from high pressure flash chamber 38 via line 44 for further processing using techniques known in the art. Preferably they are passed to low pressure flash chamber 46 and thereafter recovered as polymer product via line 48. The entrained liquid (primarily diluent) flashes overhead and passes through compressor 47 to line 42 thus forming combined line 49. This high pressure/low pressure flash design is broadly disclosed in Hanson and Sherk, U.S. Pat. No. 4,424,341 (Jan. 3, 1984), the disclosure of which is hereby incorporated by reference.

Thus in accordance with one embodiment of the invention, the slotted entry to a continuous take off is operated in conjunction with a high pressure/low pressure flash system. The continuous take off not only allows for higher solids concentration in the reactor, but also allows better operation of the high pressure flash, thus allowing the majority of the withdrawn diluent to be flashed off and recycled with no compression. This is because of several factors. First of all, because the flow is continuous instead of intermittent, the flash line heaters work better. Also, the subsequent pressure drop is more efficient because of the continuous flow thus giving better cooling.

In accordance with another embodiment of the invention the reactor effluent passes directly to the low pressure flash chamber 46 via line 45. When operating with both flash chambers, valve 37 is closed and valves 41, 43 and 51 are open. However in accordance with this alternative embodiment of the invention, valves 41, 43 and 51 are closed and valve 37 is open or else no high pressure flash chamber is present at all. The slotted entry to the continuous take off allows such high solids concentration that it is feasible to use only the low pressure flash and compress the small amount of diluent present. In this single flash embodiment, the flash line heater formed by conduit 40 can be eliminated; if desired, however, the flash line heater can be used in conjunction with a single flash chamber (i.e. flash chamber 46) which can be operated at reactor pressure or at the typical pressure for the low pressure zone.

Referring now again to FIG. 2, there is shown a smooth curved section of pipe with continuous take off mechanism 34 depicted in greater detail. The continuous take off mechanism comprises a take off cylinder 52, a slurry withdrawal line 54, an emergency shut off valve 55, a proportional motor valve 58 to regulate flow and a flush line 60. The reactor is run “liquid” full. Because of dissolved monomer the liquid has slight compressibility, thus allowing pressure control of the liquid full system with a valve. Diluent input is generally held constant, the proportional motor valve 58 being used to control the rate of continuous withdrawal to maintain the total reactor pressure within designated set points.

Throughout this application, the weight of catalyst is disregarded since the productivity, particularly with chromium oxide on silica, is extremely high.

The present invention is applicable to removing solids from any slurry stream flowing through an arc where the solids are heavier than the liquid, as for instance in concentrating mineral slurries. The term “arc” is used herein in its broadest sense to include not only an arc of a circle but any “bow-like” curved path.

The invention is of primary utility, however, in olefin polymerizations in a loop reactor utilizing a diluent, so as to produce a product slurry of polymer and diluent. Suitable olefin monomers are 1-olefins having up to 8 carbon atoms per molecule and no branching nearer the double bond than the 4-position. The invention is particularly suitable for the homopolymerization of ethylene and the copolymerization of ethylene and a higher 1-olefin such as butene, 1-pentene, 1-hexene, 1-octene or 1-decene. Especially preferred is ethylene and 0.01 to 20, preferably 0.01 to 5, most preferably 0.1 to 4 weight percent higher olefin based on the total weight of ethylene and comonomer. Alternatively sufficient comonomer can be used to give the above-described amounts of comonomer incorporation in the polymer.

Suitable diluents (as opposed to solvents or monomers) are well known in the art and include hydrocarbons which are inert or at least essentially inert and liquid under reaction conditions. Suitable hydrocarbons include isobutane, n-butane, propane, n-pentane, i-pentane, neopentane and n-hexane, with isobutane being especially preferred.

Suitable catalysts are well known in the art. Particularly suitable is chromium oxide on a support such as silica as broadly disclosed, for instance, in Hogan and Banks, U.S. Pat. No. 2,285,721 (March 1958), the disclosure of which is hereby incorporated by reference. Also suitable are organometal catalysts including those known in the art as “Ziegler” or “Ziegler-Natta” catalysts.

While this invention has been described in detail for the purpose of illustration, it is not to be construed as limited thereby, but is intended to cover all changes within the spirit and scope thereof.

That which is claimed is:

1. A loop reactor apparatus comprising:
a plurality of vertical pipe segments;
a plurality of upper lateral pipe segments;
a plurality of lower lateral pipe segments;
wherein each of said vertical pipe segments is connected at an upper end thereof to one of said upper lateral pipe segments, and is connected at a lower end thereof to one of said lower lateral pipe segments thus defining a continuous flow path adapted to convey a fluid slurry, said reactor being substantially free from internal obstructions;
means for introducing monomer reactant, polymerization catalyst and diluent into said reactor;
means for continuously moving said slurry along said flow path;
at least one elongated hollow appendage for continuously withdrawing product slurry; and
channel means in at least one of said pipe sections, said channel means being in fluid communication with said at least one elongated hollow appendage.

2. An apparatus according to claim 1 wherein said at least one elongated hollow appendage is attached to a curved portion of one of said lower lateral pipe segments thus giving a curved appendage-carrying lower pipe segment.

3. Apparatus according to claim 2 wherein said elongated hollow appendage is attached to said curved appendage-carrying lower pipe segment at an attachment angle between 0 and 90 degrees.

4. Apparatus according to claim 3 wherein said attachment angle is 0 degrees.

5. An apparatus in accordance in accordance with claim 2 wherein said elongated hollow appendage is attached to said curved appendage-carrying lower pipe segment at a radial angle of 0 degrees and an attachment angle of 90 degrees.

6. Apparatus according to claim 2 wherein said channel means has a width within the range of 0.04 to 0.25 times the diameter of said appendage carrying lower pipe segment, a depth within the range of 0.5 to 1 times said width, a radius, R, having a value within the range of 0.01 to 0.25 times said width and a radius, r, having a value of 0.

7. Apparatus according to claim 6 wherein said placement angle is between 0 and plus 90 degrees.

8. Apparatus according to claim 2 wherein said at least one appendage is a plurality of appendages

9. Apparatus according to claim 2 comprising in addition an elongated flash line in fluid communication with said at least one elongated hollow appendage for transferring product slurry from said appendage to a flash means.

10. Apparatus according to claim 9 wherein said flash line has a heater associated therewith and wherein said flash line is in fluid communication with a first flash zone having an overhead outlet and a bottoms outlet, and wherein said apparatus comprises in addition a second flash zone, said second flash zone being in fluid communication with said bottoms outlet of said first flash zone.

11. Apparatus according to claim 9 wherein said flash means consists of a single flash chamber.

12. Apparatus comprising a pipe having a take off means for continuously removing a portion of slurry flowing in said pipe, said pipe having a channel in a section thereof leading up to, and in open communication with, said take off means and wherein at least a portion of said section is in the shape of an arc.

13. A polymerization process comprising:
polymerizing, in a loop reaction zone, at least one olefin monomer in a liquid diluent to produce a fluid slurry comprising liquid diluent and solid olefin polymer particles;
circulating said slurry through an arc and into a small lateral concentration zone to produce a concentrated slurry;
continuously withdrawing, from at least one area in said concentration zone, said concentrated slurry comprising withdrawn liquid diluent and withdrawn solid polymer particles as an intermediate product of said process.

14. A process according to claim 13 wherein said olefin monomer comprises ethylene and 0.01-5 weight percent hexene based on the total weight of said ethylene and said hexene, and wherein said liquid diluent is cyclohexane.

15. A process according to claim 13 wherein said reaction zone is maintained liquid full.

16. A process according to claim 13 wherein said reaction zone has a volume of greater than 20,000 gallons and said concentration zone has a volume of between 0.02 to 3 gallons.

17. A process according to claim 13 wherein said intermediate product of said process is passed to a single flash zone wherein a major portion of said liquid diluent is vaporized and thus separated from said withdrawn solid particles, the thus separated diluent being recycled.

18. A process according to claim 13 wherein said intermediate product of said process is continuously passed through a heating zone wherein said intermediate product is heated to produce a heated intermediate product and thereafter said heated intermediate product is exposed to a pressure drop in a high pressure flash zone, said heated intermediate product having been heated to an extent such that a major portion of said withdrawn liquid diluent is vaporized and thus separated from said withdrawn solid polymer particles, the thus separated withdrawn liquid diluent thereafter being condensed for recycle, without any compression, by heat exchange.

19. A process according to claim 13 wherein said at least one area is exactly one area.

20. A process according to claim 13 wherein said at least one area is a plurality of areas.
